(19) United States
(12) Patent Application Publication
(10) Pub. No.: US 2024/0336825 A1
(43) Pub. Date: Oct. 10, 2024

(54) COOLANT COMPOSITION

(71) Applicant: TOYOTA JIDOSHA KABUSHIKI KAISHA, Aichi-ken (JP)

(72) Inventor: Yasuaki KODAMA, Seto-shi (JP)

(73) Assignee: TOYOTA JIDOSHA KABUSHIKI KAISHA, Aichi-ken (JP)

(21) Appl. No.: 18/623,030

(22) Filed: Apr. 1, 2024

(30) Foreign Application Priority Data
Apr. 4, 2023 (JP) 2023-060714

(51) Int. Cl. C09K 5/10

(52) U.S. Cl. CPC C09K 5/10

(57) ABSTRACT

A coolant composition capable of maintaining an insulating property even when water is mixed in, reducing odor, and having high workability when a coolant is replaced is provided. The coolant composition of the present disclosure contains mineral oil and/or synthetic oil, and boric acid ester. A conductivity of the coolant composition is set to less than 0.1 μS/cm.

### CROSS REFERENCE TO RELATED APPLICATIONS

This application is based upon and claims the benefit of priority from Japanese patent application No. 2023-060714, filed on Apr. 4, 2023, the disclosure of which is incorporated herein in its entirety by reference.

### BACKGROUND

The present disclosure relates to a coolant composition.

Japanese Unexamined Patent Application Publication No. 2021-31597 discloses a nonaqueous coolant composition having excellent insulating and heat transfer properties, including at least one type of carboxylic acid ester compound and substantially no water.

### SUMMARY

When a coolant composition is used, for example, for cooling electric vehicle batteries, it is necessary to replace the coolant composition. Therefore, a coolant composition with high workability is required. In addition, water may be mixed in the coolant composition due to condensation, etc., and the lowering of the insulating property of the coolant composition becomes a problem. For example, in the case of coolant leakage that may occur in an accident or the like of an electric vehicle, an insulating property sufficient to prevent the coolant from contacting the battery terminal and shorting out is required.

The present disclosure is made in consideration of the above problem, and is intended to provide a coolant composition capable of maintaining insulating property even when water is mixed in, reducing odors, and providing high workability when the coolant is replaced.

To solve the above problem and achieve the purpose, the present disclosure provides the following coolant composition.

A coolant composition according to the present disclosure contains: mineral oil and/or synthetic oil; and boric acid ester. A conductivity of the coolant composition is set to be less than 0.1 μS/cm.

According to the coolant composition of the present disclosure, even if water is mixed into the oil, the addition of boric acid ester to the oil will hydrolyze, for example, boric acid ester (B(OR)₃: where R is independently an organic group) to give ROH and HOB(OR)₂ or (HO)₂B(OR). As a result, the coolant composition of the present disclosure can absorb water and maintain the insulating property. Furthermore, the boric acid ester does not have a molecular structure that causes the odor, so the odor can be greatly reduced. As a result, the workability when replacing the coolant composition can be greatly increased.

In the coolant composition according to one form of the present disclosure, the boric acid ester is represented by a general formula B(OR)₃. Preferably, the R is independently an alkyl group and/or an organic group having an aromatic ring, and the total carbon number of the three Rs is 18 to 54.

Thus, the dispersibility of boric acid ester for mineral oil and/or synthetic oil can be enhanced.

According to the coolant composition of the present disclosure, it is possible to provide a coolant composition capable of maintaining insulating property even when water is mixed in, reducing odors, and providing high workability when replacing the coolant.

The above and other objects, features and advantages of the present disclosure will become more fully understood from the detailed description given hereinbelow and the accompanying drawings which are given by way of illustration only, and thus are not to be considered as limiting the present disclosure.

### DESCRIPTION OF EMBODIMENTS

The present disclosure will be described in detail below. It goes without saying that other embodiments are included in the present disclosure as long as they conform to the purpose of the present disclosure.

The coolant composition of the embodiment is applied to, for example, coolants of batteries, inverters, oil coolers, and radiators provided in electric vehicles, and has an excellent insulating property.

The coolant composition of the embodiment contains mineral oil and/or synthetic oil and boric acid ester. The conductivity of the coolant composition of the embodiment is less than 0.1 μS/cm. The boric acid ester is preferably a compound represented by the following formula. Formula: B(OR)₃ In the formula, each R is independently an organic group. R is preferably a hydrocarbon group, but may include heteroatoms such as oxygen and nitrogen atoms. The hydrocarbon group includes, for example, chain (including linear or branched) or alicyclic aliphatic group, aromatic group, and any combination thereof. R may have a substituent. Examples of the substituent include a hydroxyl group, an amino group, a carboxy group, and a halogen. Although the three Rs in the above formula may be different from one another as described above, they are preferably the same.

Specific examples of boric acid ester include trimethyl borate, triethyl borate, tripropyl borate, triisopropyl borate, tributyl borate, triisobutyl borate, tripentyl borate, trihexyl borate, trioctyl borate, triisooctyl borate, trinonyl borate, tridecyl borate, tridodecyl borate, trihexadecyl borate, trioctadecyl borate, triphenyl borate, tricyclohexyl borate, tribenzyl borate, triethanolamine borate, tris-o-phenylene bisborate, bis-o-phenylene pyroborate, bis-2, 3-dimethylethylene phenylene pyroborate, bis-2, 2-dimethyltrimethylene pyroborate, tris (2-ethylhexyloxy) borane, bis (1, 4, 7, 10-tetraoxaundecyl) (1,4, 7, 10,13-pentaoxatetradecyl) (1,4, 7-trioxaundecyl) borane, 2-(β-dimethylaminoisopropoxy)-4, 5-dimethyl-1,3, 2-dioxaborolane, 2-(β-diethylaminoethoxy)-4,4, 6-trimethyl-1,3, 2-dioxaborinane, 2-(β-dimethylaminoethoxy)-4,4, 6-trimethy-1,3, 2-dioxaborinane, 2-(β-diisopropylaminoethoxy)-1, 3, 2-dioxaborinane, 2-(β-diisopropylaminoethoxy)-4-methyl-1,3, 2-dioxaborinane, 2-(γ-dimethylaminopropoxy)-1, 3, 6, 9-tetrapxa-2-boracycloundecane, 2-(β-dimethylaminoethoxy)-4, 4-(4-hydroxybutyl)-1, 3, 2-dioxaborinane, and 2, 2-oxybis (5, 5-dimethyl-1, 3, 2-dioxabonarin).

From the viewpoint of enhancing the dispersibility with mineral oil and/or synthetic oil, it is preferable, in the boric acid ester, that R in general formula B(OR)₃ is an alkyl group and/or an organic group having an aromatic ring independently. In addition, it is preferable that the total carbon number of the three Rs is 18-54. It is more preferable that each R is an alkyl group and/or a group having an aromatic ring having a carbon number of 6-18.

The coolant composition of the embodiment can trap water by hydrolysis of the contained boric acid ester even if water is mixed by condensation or the like during use in an electric vehicle, for example. Therefore, this coolant composition can maintain the required insulating property. The required insulating property is an insulating property sufficient to prevent the coolant from coming into contact with the battery terminal and shorting out when, for example, coolant leakage occurs due to an accident or the like of an electric vehicle. In the coolant composition according to the embodiment, the required insulating property can be obtained when the conductivity of the coolant composition is less than 0.1 μS/cm. It is more preferable that the conductivity of the coolant composition is less than 0.0009 μS/cm.

In addition, besides boric acid ester, a desired additive may be contained in the coolant composition according to the embodiment. Examples of the additive include an antioxidant, a rust inhibitor, a viscosity index improver, a pour point hardener, a dispersant, a surface active agent, an antiwear additive, an antifoam material, and a flow antistatic agent.

When the coolant composition according to the embodiment is used by forced convection using a pump or the like, the viscosity of the coolant composition is preferably set to 10 mm²/s or less at 40° C. For example, the viscosity of the coolant composition can be adjusted by reducing the viscosity of the contained mineral oil or by the content mass % of the contained mineral oil.

The cooling system includes, for example, a refrigerant pipe through which the coolant composition, which is a refrigerant, flows, a reserve tank containing the coolant composition, a circulation device for circulating the coolant composition in a circulation path, or a cooling device for reducing the temperature of the coolant composition. The circulation device includes, for example, an electric pump. The cooling device includes, for example, a radiator, a chiller or an oil cooler. The cooling object of the cooling system is heating equipment such as an inverter, a converter, a generator, a motor, or a battery.

The configuration of the cooling system is not particularly limited. The cooling system includes, for example, a refrigerant pipe, a reserve tank, an electric pump, a radiator, and a cooling unit provided in a heating equipment. The cooling unit is a part that receives heat from the heating equipment. For example, the coolant composition is pumped from the reserve tank by the electric pump, then the heating equipment is cooled by the cooling unit, and then the coolant composition returns to the reserve tank via a downstream radiator. The temperature of the coolant composition that has cooled the cooling unit is increased, and then the temperature of the coolant composition is lowered by the radiator. An oil cooler may be arranged in the middle of the refrigerant pipe, and the motor may be cooled by the oil cooler.

### EXAMPLES

Hereinafter, this embodiment will be described more specifically with reference to examples.

### <Raw Materials>

Tributyl borate (boric acid ester)
Trihexyl borate (boric acid ester)
Trioctyl borate (boric acid ester)
Tritetradecyl borate (boric acid ester)
Trioctadecyl borate (boric acid ester)
Ethyl n-octanoate
Mineral oil: dynamic viscosity (20° C.) 0.1-10 mm²/s
LLC stock solution (Toyota genuine, product name: Super Long Life Coolant, including ethylene glycol and additives.)
Ethylene glycol (manufactured by Tokyo Chemical Industry Co., Ltd.)
Ion-exchange water

### Example 1

The coolant composition according to Example 1 was prepared by mixing 90 mass % mineral oil and 10 mass % trihexyl borate as the base oil.

### Examples 2-4, Comparative Examples 1-5

The coolant composition in each example was prepared by the same method as in Example 1 except that the composition and the content were changed to those shown in Table 1.

### (Conductivity)

The conductivity of the coolant composition in each example was measured by measuring each coolant composition heated to 20° C. using a conductivity measuring machine (manufactured by Yokogawa Electric Corporation, Personal SC Meter SC72, Detector: SC72SN-11).

### (Checking Whether Water Remains)

To the coolant composition in each example, 0.3 mass % of water was added, and the mixture was heated while stirring at 50° C. for 15 minutes. After that, the presence or absence of water droplets was confirmed visually, and the presence or absence of remaining water was determined.

### (Cooling Performance)

The cooling performance of the radiator was calculated by the following equation using the coolant composition in each example as a refrigerant. The results are shown in Table 1. The refrigerant was adjusted so that the inlet temperature was 65° C. The other conditions are as follows. Air flow rate to radiator: 4.5 m/sec, refrigerant flow rate: 10 L/min, temperature difference between refrigerant and outside air: 40° C. (coolant: 65° C., outside air: 25° C.).

$${Q}_{w} = \frac{{V}_{w} \cdot {γ}_{w} \cdot {10}^{- 3}}{60} \cdot {C}_{pw} \cdot ( {t}_{w 1} - {t}_{w 2} ) \qquad [ Expression 1 ]$$

QW: cooling performance, V_{W}: refrigerant flow rate, γ_{W}: refrigerant density, C_{PW}: refrigerant specific heat, t_{W1}: refrigerant inlet temperature, t_{W2}: refrigerant outlet temperature

### (Odor Intensity)

The odor of the coolant composition in each example was evaluated based on the following criteria in accordance with the provisions under the Offensive Odor Control Law. 0: No odor. 1: Detection threshold concentration (odor that can be barely sensed). 2: Cognitive threshold concentration (faint odor that can be identified what it is). 3: Easily noticeable odor. 4: Strong odor. 5: Very strong odor.

[Table 1]

TABLE 1

| | | | | | | | Comparative | Comparative | Comparative | Comparative |
|---|---|---|---|---|---|---|---|---|---|---|
| Item | Details of item | | Example 1 | Example 2 | Example 3 | Example 4 | Example 1 | Example 2 | Example 3 | Example 4 |
| Composition | Boric | Tributyl borate | | | | | | | | |
| (mass %) | acid | Trihexyl borate | 10 | | | | | | | |
| | ester | Trioctyl borate | | 7 | | | | | | |
| | | Tritetradecyl | | | 5 | | | | | |
| | | borate | | | | | | | | |
| | | Trioctadecyl | | | | 3 | | | | |
| | | borate | | | | | | | | |
| | Ethyl n-octanoate | | | | | | | | | 10 |
| | Mineral oil | | 90 | 93 | 95 | 97 | | | | 90 |
| | LLC stock solution | | | | | | 50 | | | |
| | Ethylene glycol | | | | | | | 50 | | |
| | Ion-exchange water | | | | | | 50 | 50 | 100 | |
| Total (mass %) | | | 100 | 100 | 100 | 100 | 100 | 100 | 100 | 100 |
| Performance | Conductivity | A: less than | A | A | A | A | C | C | C | A |
| | | 0.0009 μS/cm | <0.0009 | <0.0009 | <0.0009 | <0.0009 | 7000 | 0.6 | 0.3 | <0.0009 |
| | | B: less than | | | | | | | | |
| | | 0.1 μS/cm | | | | | | | | |
| | Remaining | Water droplets | No | No | No | No | No | No | No | No |
| | water | | | | | | | | | |
| | Cooling radiator W/K | | 190 | 190 | 190 | 190 | 371 | 368 | 458 | 190 |
| | Odor | | 2 | 2 | 2 | 2 | 2 | 2 | 0 | 4 |
| | Intensity | | | | | | | | | |

The coolant composition in each example had conductivity of less than 0.0009 μS/cm and thus had an excellent insulating property. In addition, the cooling performance of the radiator using the coolant composition in each example was 190 W/K or more and thus had sufficient cooling performance for practical use. In addition, it was confirmed that water droplets were not detected in the coolant composition in each example. In addition, it was confirmed that the odor of the coolant composition in each example was 2, which was the cognitive threshold concentration. On the other hand, the conductivities of the coolant compositions in Comparative Examples 1-3 were respectively 7000 μS/cm, 0.6 μS/cm, and 0.3 μS/cm, and thus the insulating properties were insufficient. In the coolant compositions in Comparative Examples 4 and 5, the conductivities were less than 0.0009 μS/cm, and thus the insulating properties were excellent. However, in Comparative Example 4, water droplets were visually recognized in the test described above, and in Comparative Example 5, the odor was 4, and there was a problem in workability when the coolant was exchanged.

From the above results, it has been verified that the coolant compositions according to the embodiment (the coolant compositions in Examples 1-4) have excellent insulating properties, which can be maintained even when water is mixed in due to condensation or the like when the coolant composition is used in an electric vehicle, and odors can be reduced.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coolant composition containing:
mineral oil and/or synthetic oil; and
boric acid ester,
wherein a conductivity of the coolant composition is less than 0.1 μS/cm.

2. The coolant composition according to claim 1, wherein
the boric acid ester is represented by a general formula B(OR)₃, and
the R is independently an alkyl group and/or an organic group having an aromatic ring, and the total carbon number of the three Rs is 18 to 54.
